(19) United States
(12) Patent Application Publication
(10) Pub. No.: US 2024/0210764 A1
(43) Pub. Date: Jun. 27, 2024

(54) LIQUID CRYSTAL LENS, DRIVING METHOD, EYEGLASSES, ELECTRONIC PRODUCT, VR DEVICE, AND AR DEVICE

(71) Applicant: CHENGDU YETA TECHNOLOGY CO., LTD., Chengdu (CN)

(72) Inventors: Wenbin FENG, Chengdu (CN); Zhiqiang LIU, Chengdu (CN); Bin WANG, Chengdu (CN)

(73) Assignee: CHENGDU YETA TECHNOLOGY CO., LTD., Chengdu (CN)

(21) Appl. No.: 18/599,102

(22) Filed: Mar. 7, 2024

Related U.S. Application Data
(63) Continuation of application No. PCT/CN2022/073612, filed on Jan. 25, 2022.

(51) Int. Cl. G02F 1/1343; G02B 3/14; G02B 27/01; G02F 1/29

(52) U.S. Cl. CPC G02F 1/1343; G02B 3/14; G02B 27/0172; G02F 1/29; G02B 2027/0178

(57) ABSTRACT

A liquid crystal lens, a driving method, eyeglasses, an electronic product, a VR device, and an AR device are provided. The liquid crystal lens comprise a liquid crystal layer, a first electrode layer, a second electrode layer, a first transparent substrate, and a second transparent substrate. The first and second electrode layers are respectively located on opposite sides of the liquid crystal layer. The first transparent substrate is positioned on side of the first electrode layer opposite to the liquid crystal layer, and the second transparent substrate is positioned on the side of the second electrode layer opposite to the liquid crystal layer. The second electrode layer includes a first electrical connector, a second electrical connector, and several conductive wires. The driving method of the liquid crystal lens is simple and can achieve an ideal potential distribution, unaffected by variations in the characteristics of high-resistance films.

### CROSS REFERENCE OF RELATED APPLICATION

The present disclosure is a continuation of International Patent Application No. PCT/CN2022/073612, filed on Jan. 25, 2022. All of the aforementioned patent applications are hereby incorporated by reference in their entireties.

### FIELD OF INVENTION

The present invention belongs to the field of liquid crystal lens technology, specifically relating to a liquid crystal lens, a driving method, eyeglasses, an electronic product, a VR device, and an AR device.

### DESCRIPTION OF RELATED ARTS

Nearsighted patients commonly use the approach of wearing myopic glasses for correction. However, as people age, they may also experience presbyopia. In order to reduce the impact of myopia and presbyopia on daily life, patients often need to prepare two pairs of different glasses: one for seeing distant objects (myopic glasses) and another for seeing close-up objects (presbyopic glasses). The frequent need to switch between glasses brings inconvenience to patients.

Furthermore, in VR or AR devices, due to the fact that users' left and right eyes correspond to different screens and individuals have different facial features and interpupillary distances, if the focal length of the optical lens in VR or AR devices remains constant, it will inevitably affect users' experience while wearing the devices.

To address these issues, adjustable liquid crystal lenses with variable focal lengths have been considered for application in this field. Currently, achieving large-aperture liquid crystal lenses requires the use of high-resistance films. However, the resistance of high-resistance films is unstable, and ensuring uniformity is challenging, which has been a long-standing problem. In addition, a large number of individually controlled concentric electrode structures can also be used for the design of large-aperture liquid crystal lenses, but the driving process is complex.

In existing technology, there are proposals for designing liquid crystal lenses using a single helical electrode structure. For example, the patent with international publication number WO2021/113963A1 adopts a helical electrode structure. However, this patent does not provide a clear definition of the shape of the helical electrode based on the desired phase distribution, making it difficult to achieve the desired phase distribution.

### SUMMARY OF THE PRESENT INVENTION

In view of these challenges, the present invention provides a liquid crystal lens, a driving method, an eyeglasses, an electronic product, a VR device, and an AR device to solve the existing technical problem of large-aperture liquid crystal lenses requiring multiple electrodes that need to be independently driven with voltage, which cannot achieve an ideal and stable potential distribution.

The technical solutions employed in the present invention are as follows:

On the first aspect, the present invention provides a liquid crystal lens.

On the second aspect, the present invention provides eyeglasses comprising the liquid crystal lens according to the first aspect.

On the third aspect, the present invention provides a VR device comprising the liquid crystal lens according to the first aspect.

On the fourth aspect, the present invention provides an AR device comprising the liquid crystal lens according to the first aspect.

On the fifth aspect, the present invention provides an electronic product comprising a control circuit and the liquid crystal lens according to the first aspect, wherein the control circuit is electrically connected to the liquid crystal lens.

On the sixth aspect, the present invention provides a driving method for the liquid crystal lens according to the first aspect, used to drive the liquid crystal lens as claimed in the first aspect.

### Beneficial Effect

The liquid crystal lens, driving method, eyeglasses, electronic product, VR device, and AR device of the present invention utilizes an electrode array to electrically connect circular electrode holes and transparent circular electrodes located at the center of the electrode holes. By optimizing the potential distribution through limiting the spacing between adjacent conductive lines in the electrode array to below 100 μm, the voltage distribution of the liquid crystal lens approaches an ideal distribution and becomes smoother. The present invention only requires applying driving voltages to the opposite ends of the conductive lines to achieve a more ideal spatial electric field distribution, thereby achieving the effect of a large-aperture liquid crystal lens. Compared to the traditional method of using concentric circular ring electrodes, the present invention requires fewer electrodes that need independently loaded driving voltages, resulting in simpler driving and avoiding abrupt potential changes. Furthermore, it is not affected by changes in the characteristics of high-resistance films, ensuring long-term stability of the potential distribution.

### BRIEF DESCRIPTION OF THE DRAWINGS

To provide a clearer understanding of the technical embodiments of the present invention, the following brief descriptions of the accompanying drawings used in the embodiments will be provided. It should be understood by those skilled in the art that, without exerting any creative effort, additional drawings can be derived based on these drawings, and all such variations are within the scope of the present invention.

FIG. 1 is a schematic diagram of the three-dimensional structure of the liquid crystal lens according to the present invention.

FIG. 2 is a schematic diagram of the structure of the liquid crystal lens after removing the second transparent substrate to expose the second electrode layer.

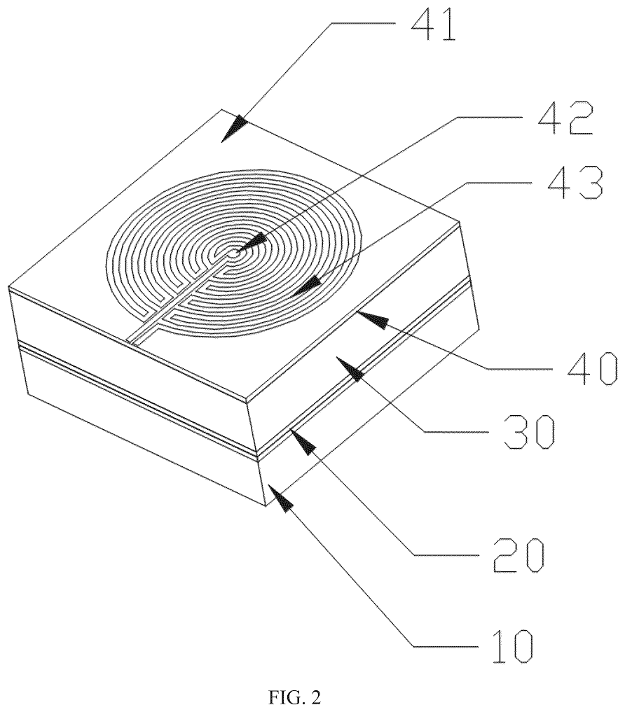

FIG. 3 is a schematic diagram of the structure of the second electrode layer according to the present invention.

FIG. 4 is a schematic diagram of the optimal curve according to the present invention.

FIG. 5 is a schematic diagram of the electrode array according to the present invention when using multiple conductive lines.

FIG. 6 is a schematic diagram of the electrode array according to the present invention when using a single spiral-shaped conductive line.

FIG. 7 is a schematic diagram of the optimal curves with different parameters according to the present invention.

FIG. 8 is a schematic diagram of the structure in which the conductive lines used in the present invention are avoiding the first electrode lead.

FIG. 9 is a flowchart illustrating the driving method of the liquid crystal lens according to the present invention.

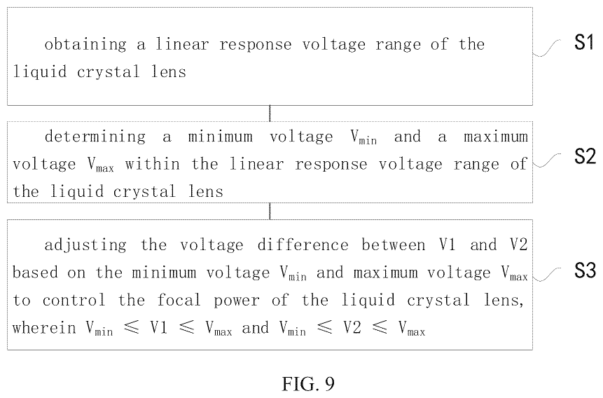

FIG. 10 is a schematic diagram of the structure of the driving device for the liquid crystal lens according to the present invention.

FIG. 11 is an interference fringe pattern of the liquid crystal lens according to the present invention.

FIG. 12 is a schematic diagram of the structure of the second electrode layer of the present invention using the combination of equipotential wire and conductive wire.

The accompanying drawings are labeled as follows:
First transparent substrate 10
First electrode layer 20
Liquid crystal layer 30
Second electrode layer 40
Circular hole electrode 41
Circular transparent electrode 42
Electrode array 43
Conductive wire 431
Equipotential wire 44
Second transparent substrate 50
First electrode lead 60
Outermost curved segment 4311
Innermost curved segment 4312
Intermediate curved segment 4313
Connecting segment 4314

### DETAILED DESCRIPTION

In order to provide a clear and comprehensive description of the objectives, technical solutions, and advantages of the embodiments of the present invention, the following detailed description will be provided in conjunction with the embodiments of the present invention. It should be noted that in this document, terms such as “first” and “second” are used merely to distinguish one entity or operation from another, and do not necessarily imply any actual relationship or order between these entities or operations. In the description of the present invention, it should be understood that terms such as “center,” “up,” “down,” “front,” “back,” “left,” “right,” “vertical,” “horizontal,” “top,” “bottom,” “inner,” “outer,” and the like indicate orientations or positional relationships based on the orientations or positional relationships shown in the drawings, and are used for the purpose of facilitating the description and simplifying the description, rather than indicating or implying that the device or component referred to must have a specific orientation or be constructed and operated in a specific orientation. Therefore, they should not be understood as limiting the present invention. Furthermore, terms such as “comprise,” “include,” or any other variations thereof are intended to encompass non-exclusive inclusion, such that processes, methods, articles, or devices comprising a series of elements include not only those elements explicitly listed, but also other elements that are not explicitly listed but are inherent to such processes, methods, articles, or devices. Unless otherwise limited, the elements defined by the phrase “comprising . . . ” do not exclude the presence of additional identical elements in the processes, methods, articles, or devices that include the elements. If not conflicting, the embodiments and features thereof may be combined with each other and fall within the scope of protection of the present invention.

### Embodiment 1

The present embodiment provides a liquid crystal lens, the liquid crystal lens comprises a liquid crystal layer 30, a first electrode layer 20, a second electrode layer 40, a first transparent substrate 10, and a second transparent substrate 50. The first electrode layer 20 and the second electrode layer 40 are respectively located on opposite sides of the liquid crystal layer 30. The first transparent substrate 10 is positioned on one side of the first electrode layer 20 opposite from the liquid crystal layer 30, and the second transparent substrate 50 is positioned on one side of the second electrode layer 40 opposite from the liquid crystal layer 30.

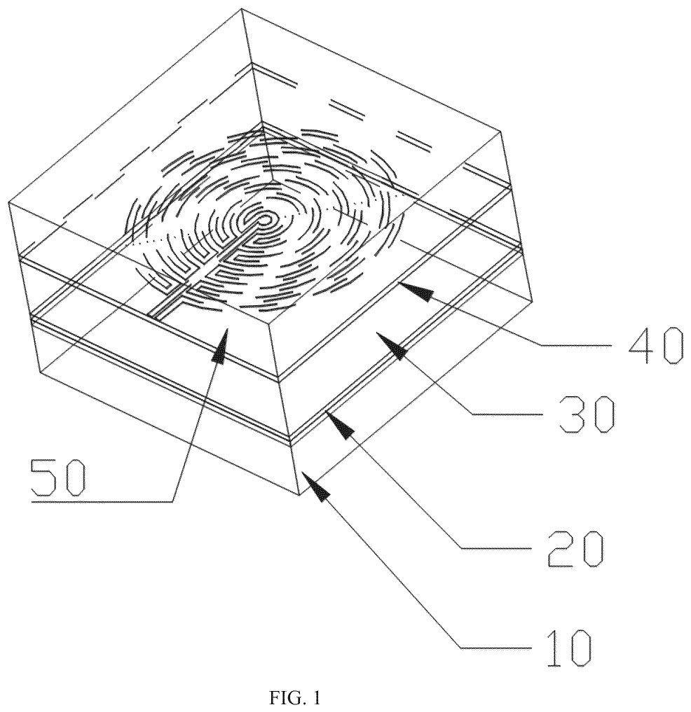

In this embodiment, the liquid crystal lens can adopt a layered structure. The aforementioned first transparent substrate 10, first electrode layer 20, liquid crystal layer 30, second electrode layer 40, and second transparent substrate 50 are positioned in different layers, arranged in a stacked manner along the optical transmission direction of the liquid crystal lens, i.e., the normal direction of each layer. The arrangement can be seen in FIG. 1, where along the optical transmission direction of the liquid crystal lens, from bottom to top, there is the first transparent substrate, first electrode layer 20, liquid crystal layer 30, second electrode layer 40, and second transparent substrate 50. The first transparent substrate 10 and the second transparent substrate 50 can be made of transparent materials with certain strength and rigidity, such as glass substrates or plastic substrates. The first substrate can serve as a support for the liquid crystal lens and also as a carrier for the first electrode layer 20, which can be deposited on the first substrate. Similarly, the second substrate serves as a support and can also act as a carrier for the second electrode layer 40, which can be deposited on the second substrate.

The second electrode layer 40 includes a first electrical connector, a second electrical connector, and several conductive wires 431. The conductive wires 431 extend from the center of the second electrode layer towards the periphery. One end of the conductive wires 431 is electrically connected to the first electrical connector, while the opposite end is connected to the second electrical connector. In this embodiment, the conductive wires can be wires with a certain resistance or thin lines with a certain resistance and conductivity, which are plated on the second substrate. The several conductive wires 431 extend on the second electrode layer to form an electrode array 43. The term “several conductive wires 431” means that the number of conductive wires can be one or more than one.

The first electrical connector is used to provide a first driving voltage to the end portion of the conductive wires that are electrically connected to it. The second electrical connector is used to provide a second driving voltage to the end portion of the conductive wires that are electrically connected to it. In a specific implementation, the first electrical connector can be connected to a power source that provides the first driving voltage, allowing the first driving voltage from the power source to be applied to the end of the conductive wires near the center of the second electrode layer. Similarly, the second electrical connector can be connected to a power source that provides the second driving voltage, allowing the second driving voltage from the power source to be applied to the end of the conductive wires away from the center of the second electrode layer.

In this embodiment, the first electrical connector can be in the form of a closed or open-ring electrode. Similarly, the second electrical connector can also be in the form of a closed or open-ring electrode.

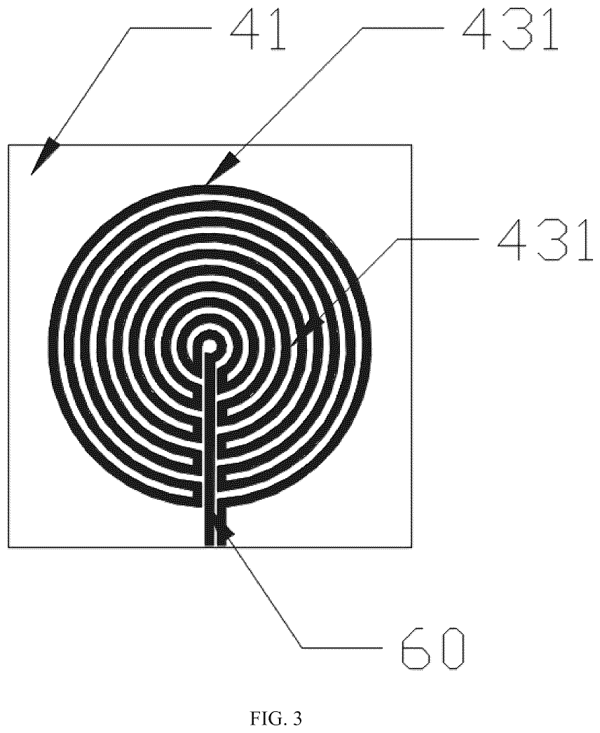

In this embodiment, the first electrical connector can be a transparent electrode, a circular electrode, a transparent circular electrode, or any other shape of transparent or opaque electrode. The second electrical connector can be a perforated electrode. The shape of the hole can be square, circular, elliptical, polygonal, or any other shape. As one preferred option, the hole-shaped electrode can be a circular electrode. As shown in FIG. 3, when a circular transparent electrode is used, the center of the circular transparent electrode (42) is located at the center of the hole in the circular hole electrode (41), and the first electrode layer (20) is a transparent electrode layer.

The circular hole electrode (41), circular transparent electrode (42), and conductive wires (431) are located in the same layer. The circular hole electrode (41) has a circular through-hole, and the circular transparent electrode (42) is positioned at the center of this circular through-hole. This arrangement creates a circular space between the hole and the circular transparent electrode (42), and the conducting wires (431) are situated within this circular space.

The electrode array (43) comprises several conductive wires (431). One end of each conducting wire (431) is electrically connected to the circular transparent electrode (42), while the opposite end is electrically connected to the circular hole electrode (41). The conductive wires (431) extend from the outer circumference of the circular transparent electrode (42) to the inner wall of the hole in the circular hole electrode (41). The spacing between adjacent conductive wires (431) is equal to or less than 100 μm.

In this embodiment, conductive wires (431) with a certain resistance value are arranged between the circular hole electrode (41) and the circular transparent electrode (42). Due to the longer length compared to width and thickness, the conductive wires (431) have a linear shape, wherein the number of conductive wires (431) can be one or more. Each end of the conductive wires (431) is electrically connected to the circular hole electrode (41) and the circular transparent electrode (42) respectively.

In this embodiment, the first electrode layer (20) is a transparent electrode layer. The circular transparent electrode (42), conductive wires (431), and circular hole electrode (41) can be made of transparent conductive materials, including but not limited to ITO electrode, IZO electrode, FTO electrode, AZO electrode, IGZO electrode, and so on.

In this embodiment, the first electrode layer (20) is used to receive the common voltage, the circular transparent electrode (42) is used to receive the first driving voltage, and the circular hole electrode (41) is used to receive the second driving voltage. Since the circular transparent electrode (42) is located in the middle of the circular hole in the circular hole electrode (41), in order to facilitate load the first driving voltage to the circular transparent electrode (42), the liquid crystal lens in this embodiment further includes electrode leads. The electrode leads are led out from the circular transparent electrode (42). One end of the electrode lead is electrically connected to the circular transparent electrode (42), while the other end is electrically connected to the control circuit that outputs the first driving voltage.

By applying voltage in the aforementioned manner, the electric field in the liquid crystal layer (30) exhibits a gradient distribution. For example, in the circular hole region of the circular hole electrode (41), the voltage in the radial direction of the liquid crystal layer (30) gradually increases from the center of the hole to the edge of the hole, with the maximum voltage at the edge. Similarly, in the circular hole region of the circular hole electrode (41), the voltage in the radial direction of the liquid crystal layer (30) gradually decreases from the center of the hole to the edge of the hole, with the minimum voltage at the edge. In this embodiment, the conductive wires (431) connected to the circular transparent electrode (42) and the circular hole electrode (41) respectively guide the potential distribution of the liquid crystal lens, allowing the potential to gradually change along the radial direction of the lens without abrupt step changes. Additionally, the liquid crystal lens in this embodiment can be driven by only the first driving voltage and the second driving voltage. By adjusting one or both of these driving voltages, it is possible to control the focal length of the liquid crystal lens, therefore this control method is simple and does not require excessive electrode lead-out wires.

Due to the electrically controllable adjustment of liquid crystal director alignment, it exhibits different refractive index gradient distributions in a non-uniform electric field. Therefore, applying a voltage with a certain gradient distribution can induce a non-uniform distribution of the liquid crystal director alignment, resulting in a specific phase distribution of the transmitted light propagating through the liquid crystal layer (30).

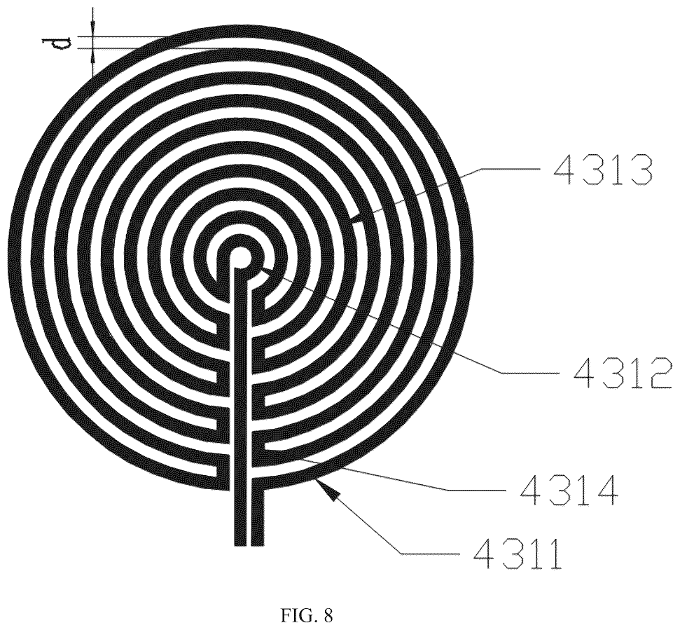

As shown in FIG. 8, where “d” represents the spacing between adjacent conductive wires (431), in this embodiment, the high-resistance film typically used to guide the potential distribution is removed, and the spacing between adjacent conductive wires (431) is kept less than or equal to 100 μm. By controlling the spacing between adjacent conductive wires (431) to be less than or equal to 100 μm in this embodiment, even without using a high-resistance film, the potential distribution can change smoothly. Moreover, since there is no high-resistance film, there will be no change in the potential distribution of the liquid crystal lens due to the characteristics of the high-resistance film.

In this embodiment, the positive and negative focal power of the liquid crystal lens can be changed by changing the magnitude relationship between the first driving voltage loaded on the circular transparent electrode 42 and the second driving voltage loaded on the circular hole electrode 41, so that the liquid crystal lens can change from a negative lens to a positive lens or a positive lens to a negative lens. For example, when the first driving voltage applied to the circular transparent electrode (42) is smaller than the second driving voltage applied to the circular hole electrode (41), the liquid crystal lens in this embodiment exhibits convex lens characteristics, in this case, eyeglasses made using this liquid crystal lens can be used as presbyopic glasses. On the other hand, by changing the relationship between the magnitudes of the first driving voltage and the second driving voltage, such that the first driving voltage applied to the circular transparent electrode (42) is greater than the second driving voltage applied to the circular hole electrode (41), the liquid crystal lens in this embodiment exhibits concave lens characteristics, in this case, eyeglasses made using this liquid crystal lens can be used as myopic glasses.

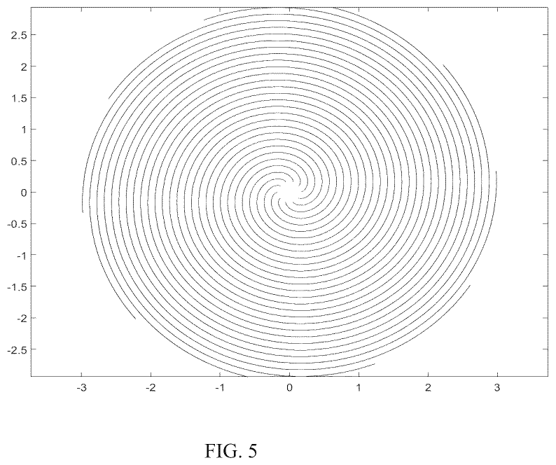

In this embodiment, as shown in FIG. 5, when the number of conductive wires (431) in the electrode array (43) is greater than or equal to 2, the conductive wires (431) are arranged along the circumference of the circular hole electrode (41). When there are a larger number of conductive wires (431), this arrangement allows for a smoother potential variation within the working area of the liquid crystal lens in this embodiment. When the conductive wires (431) are arranged with rotational symmetry around a point in the second electrode layer, the potential distribution also forms a rotationally symmetric pattern. The rotational symmetric distribution refers to a pattern formed by rotating all the conductive wires around a fixed point on the second electrode layer by a certain angle, and the resulting image of the new arrangement completely overlaps with the previous image. When the number of conductive wires is equal to or greater than 2, the first electrical connector is used to provide the same driving voltage to the ends of each conductive wire connected to it. Similarly, the second electrical connector is used to provide the same driving voltage to the ends of each conductive wire connected to it.

As a preferred embodiment, in this embodiment, the spacing between adjacent conductive wires (431) is the same. As another preferred embodiment, the width of the conductive wires (431) is the same at all locations in this embodiment.

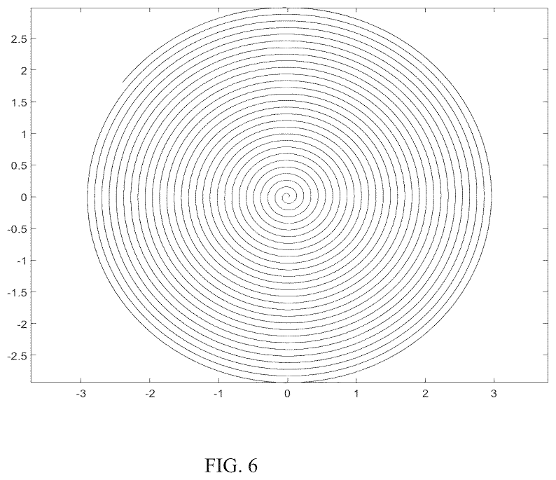

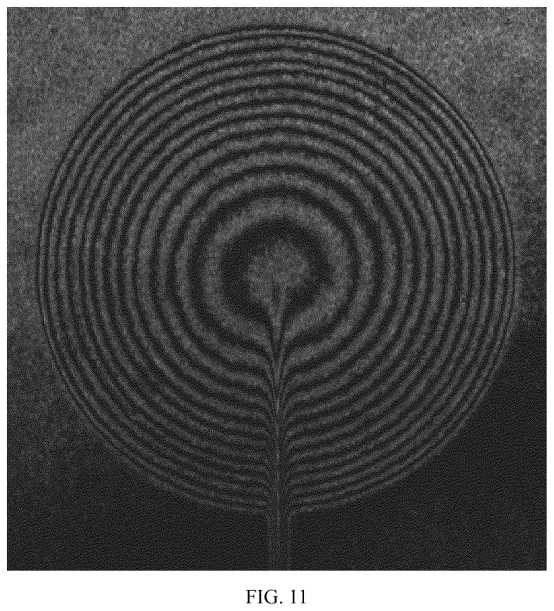

Furthermore, as shown in FIG. 6, in this embodiment, it is also possible to achieve a desirable potential distribution by using only one conductive wire (431) when the spacing between adjacent conductive wires is less than or equal to 100 μm. The effect of the liquid crystal lens obtained using the aforementioned approach is depicted in the interference fringe pattern in FIG. 11.

As a preferred embodiment, in this embodiment, the shape of the conductive wires is a spiral. The starting point of the spiral can be either the center position of the second electrode layer or a position near the center of the second electrode layer. The spiral extends in a circular direction from the starting point towards the edge of the second electrode layer, circling around in multiple rounds. As the spiral progresses from the center position of the second electrode layer towards the edge position, it fills a significant portion of the second electrode layer. The potential of the second electrode layer also gradually changes along with the extension of the spiral. Therefore, a more desirable potential distribution can be achieved.

In this embodiment, the desired potential distribution that meets various lens functionality requirements can be achieved by setting the shape of the conductive wires. The specific method for setting the shape of the conductive wires is as follows:

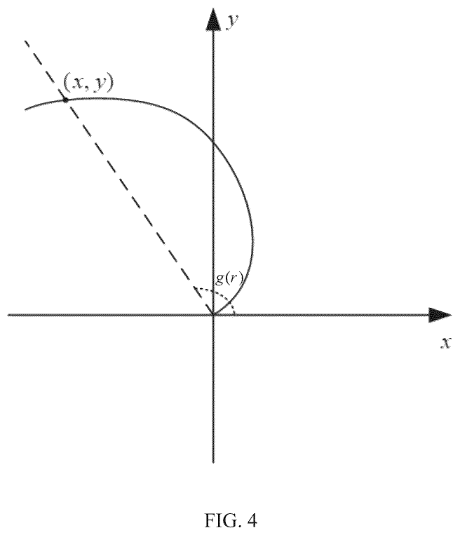

As shown in FIG. 4, in this embodiment, the shape of the conductive wires is obtained from the first spiral equation. The first spiral equation is as follows:

$$\{ \begin{matrix}x = r cos ( g ( r ) ) \\ y = r sin ( g ( r ) )\end{matrix}$$

$$g ( r ) = \pm ( \sqrt{4 {a}^{2} {r}^{2} - 1} - arctan ( \sqrt{4 {a}^{2} {r}^{2} - 1} ) )$$

Wherein ‘r’ represents the radius in polar coordinates, g(r) represents the polar angle, and ‘a’ is a parameter in the equation.

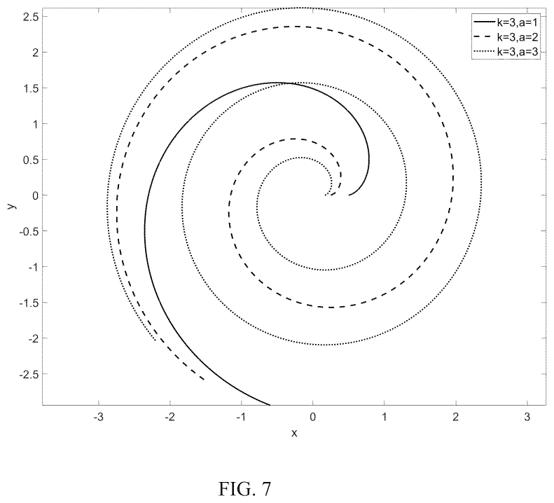

As shown in FIG. 7, when ‘a’ is larger, the radius of the circular transparent electrode 42 becomes smaller. The value of ‘a’ determines the density of the spiral lines, with larger values of a resulting in denser spiral lines. By using the aforementioned method to set the shape of the conductive wires, an accurate parabolic distribution of electric potential can be obtained. Consequently, the wavefront distribution of the resulting liquid crystal lens also exhibits an accurate parabolic distribution.

In this embodiment, the shape of the conducting line is a helix obtained by the second helix equation shown below:

$$\{ \begin{matrix}x = r cos ( g ( r ) ) \\ y = r sin ( g ( r ) )\end{matrix}$$

$$g ( r ) = \text{} \pm ( arctan ( \frac{\sqrt{{R}^{2} - {r}^{2}}}{\sqrt{( {m}^{2} + 1 ) {r}^{2} - {R}^{2}}} ) + \sqrt{{m}^{2} + 1} arc sin h ( \frac{\sqrt{{m}^{2} + 1} \sqrt{{R}^{2} - {r}^{2}}}{m R} ) )$$

Wherein ‘r’ represents the radius in polar coordinates, g(r) represents the polar angle, ‘m’ is a parameter related to the liquid crystal material, and R denotes the curvature radius of the lens.

By employing the aforementioned method to configure the conductive wires, an accurate potential distribution in spherical distribution can be achieved, resulting in an accurate spherical wavefront distribution for the obtained liquid crystal lens. Lenses with a spherical wavefront exhibit the most ideal imaging properties. However, conventional lenses require complex and precise shaping processes to achieve an approximation of a spherical wavefront distribution. In contrast, the present invention only requires the shape of the conductive wires to satisfy the aforementioned requirements in order to obtain a lens with an accurately spherical wavefront distribution. This allows for the production of high-precision spherical wavefront lenses without the need for intricate manufacturing processes, leading to a significant reduction in production costs.

The shape of the conductive wire is the helix obtained by a third helix equation, which is:

$$\{ \begin{matrix}x = r cos ( g ( r ) ) \\ y = r sin ( g ( r ) )\end{matrix}$$

Wherein ‘r’ represents the radius in polar coordinates, g(r)=±\sqrt{a²−1}ln(r)+c, ‘c’ is an arbitrary constant, which is a parameter of the equation.

By employing the aforementioned method to configure the conductive wires, an accurate conical potential distribution can be achieved, resulting in an exact conical wavefront distribution of the liquid crystal lens.

As one of the embodiments, in this embodiment, the line shape of the electrode unit is a parabola, represented by the mathematical equation:

$$y = - \frac{1}{1250} {x}^{2} + 2 x ( unit : μ m ) .$$

As one of the embodiments, in this embodiment, the shape of the conductive wire 431 is an arc, represented by the following mathematical equation:

$$y = \sqrt{125 {0}^{2} - {( x - 1250 )}^{2}} ( unit : μ m ) .$$

As one of the embodiments, in this example, the shape of the conductive wire 431 is an Archimedean spiral, represented by the following mathematical equation:

$$\{ \begin{matrix}x = 2500 t cos ( 2 k π t ) \\ y = 2500 t sin ( 2 k π t ) ( unit : μ m ) . \\ t ∈ [ 0 , 1 ]\end{matrix}$$

As one of the preferred embodiments, in this example, the line shape of the electrode unit is a Fermat spiral, represented by the following mathematical equation:

$$\{ \begin{matrix}x = 2500 \sqrt{t} cos ( 2 k π t ) \\ y = 2500 \sqrt{t} sin ( 2 k π t ) ( unit : μ m ) . \\ t ∈ [ 0 , 1 ]\end{matrix}$$

The difference between the Fermat spiral and the Archimedean spiral is that as the spiral expands outward, the radius of the Fermat spiral increases non-linearly. The further it expands, the slower the increase in the radius.

When only one conductive wire 431 is used, the liquid crystal lens in this embodiment also includes a first electrode lead 60. The first electrode lead 60 extends outward from one end of the conductor wire near the center of the second electrode layer.

In this embodiment, as shown in FIG. 8, the conductive wire 431 comprises multiple curved segments arranged from the outer side to the inner side. The arrangement from the outer side to the inner side means that the distribution follows the radial direction of the liquid crystal lens, starting from a position near the center of the second electrode layer and extending towards the edge of the second electrode layer. The direction close to the center of the second electrode layer is considered inward, while the direction away from the center of the second electrode layer is considered outward. In this embodiment, a single conductor wire 431 can be seen as composed of multiple curved segments connected end to end.

Each curved segment is disconnected at the electrode lead to avoid contact or interference with the lead. After each curved segment is disconnected at the electrode lead, it forms two end portions, with each end portion located on either side of the electrode lead.

The end of the outermost curved segment 4311 is electrically connected to the first electrode lead, the opposite end thereof is connected to the adjacent curved segment on the same side of the first electrode lead 60. The end of the curved segment closest to the center of the second electrode layer is electrically connected to the first electrode lead, and the opposite end thereof is connected to the adjacent segment on the same side of the first electrode lead 60. For the remaining curved segments, one end is connected to an adjacent curved segment on the same side of the first electrode lead 60, and the opposite end is connected to another adjacent curved segment on the same side of the first electrode lead 60.

Among the multiple curved segments that make up the conductive wire 431, two curved segments are particularly special, one of them is the outermost curved segment 4311, which is the segment closest to the center of the second electrode layer. The other is the innermost curved segment 4312, which is the one farthest from the center of the second electrode layer. The end of the outermost curved segment 4311 is connected to the second electrode connector, while the other end is connected to the next segment of the curved segment (which is closer to the center of the second electrode layer in the radial direction). The end of the innermost curved segment 4312 is connected to the circular transparent electrode 42, while the other end is connected to the previous segment of the curved segment (which is farther away from the center of the second electrode layer in the radial direction). Among all the curved segments that make up the conductive wire 431, except for the two aforementioned segments, the two ends of the remaining curved segments are connected to their adjacent curved segments. For the purpose of description in this document, these curved segments are also referred to as intermediate curved segments 4313. One end is connected to the previous segment of the curved segment, while the other end is connected to the next segment of the curved segment. This way, these curved segments are connected end-to-end, forming a conductive wire 431 that continuously extends from a position close to the center of the second electrode layer to a position at the edge of the second electrode layer, while fully filling the second electrode layer, at the same time, they cleverly avoid the first electrode lead 60, thus achieving a reasonable distribution of electric potential while avoiding the influence of the first electrode lead 60. In this embodiment, the adjacent ends of two curved segments can be connected by connecting segments 4314. One end of the connecting segment 4314 is connected to the previous segment of the curved segment, while the other end is connected to the next segment of the curved segment. The first electrode lead 60 can be a straight line, and the connecting segments 4314 can also be parallel straight lines to the first electrode lead 60.

As one of the embodiments, in this embodiment, the curved segment is an arc and the spacing between adjacent curved segments is equal. Suppose the density of the electrode along the radial direction is P, then the electrode length within the radius r can be expressed as

$$L ( r ) = {\int }_{0}^{r} 2 π r ρ d r = ρ π {r}^{2} ;$$

Separately the voltage thereof satisfies V(r)∝ρπr², therefore, in the case where the spacing between adjacent conductive wires is less than or equal to 100 μm and the density of the conductive wires in the second electrode layer is sufficiently high, the potential distribution obtained from this electrode structure conforms perfectly to a parabolic distribution.

As one embodiment, in this example, the curved segment is arc, and the spacing between at least some of the adjacent curved segments is not equal. In this embodiment, the potential distribution of the liquid crystal lens can be controlled by setting the spacing between curved segments, thus controlling the light modulation effect of the liquid crystal lens.

The spacing between the adjacent curved segments satisfies that the potential distribution formed by the liquid crystal lens is spherical. When the spacing between adjacent curved segments meets this requirement, the resulting wavefront distribution of the liquid crystal lens becomes spherical. Lenses with a spherical wavefront have ideal imaging properties. However, conventional lenses require complex and precise shaping processes to approximate a spherical wavefront distribution. In contrast, the present embodiment achieves a lens with an accurate spherical wavefront distribution by simply ensuring that the spacing between adjacent curved segments meets the specified requirement.

In this case, when the spacing between adjacent curve segments satisfies the specified requirement, the potential distribution formed by the liquid crystal lens follows a conical distribution. Consequently, the resulting wavefront distribution of the liquid crystal lens becomes conical. By ensuring that the spacing between adjacent curve segments meets the specified requirement, the lens can achieve an accurate conical wavefront distribution.

In this case, the spacing between the adjacent curved segments satisfies that the potential distribution formed by the liquid crystal lens is conical. When the spacing between adjacent curve segments meets this requirement, the resulting wavefront distribution of the liquid crystal lens becomes conical.

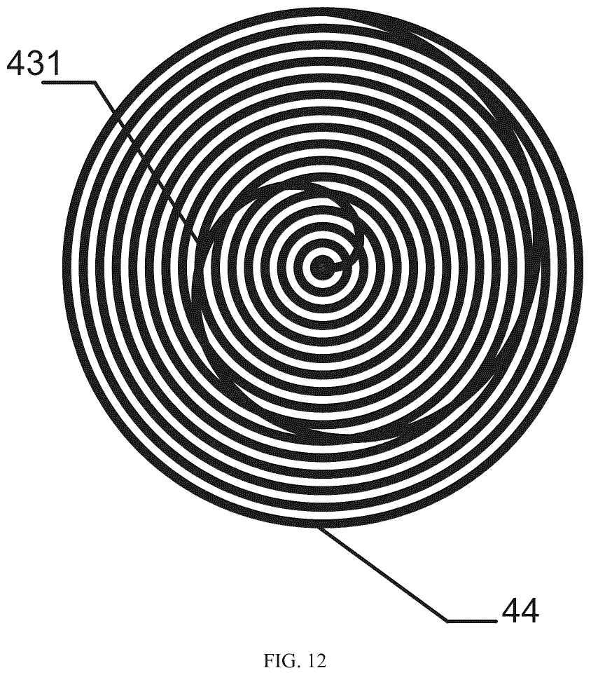

As shown in FIG. 12, as an optional but advantageous embodiment, the number of the conductive wire 431 in this embodiment is one, and the second electrode layer 40 further includes several equipotential wires 44. The several equipotential wires 44 are electrically connected to the conductive wire 431 at different positions along the conductive wire 431.

The potential at each position on the same equipotential wire 44 is equal. Since the equipotential wires 44 are electrically connected to the conductive wire 431, the potential at each position on the same equipotential wire is equal to the potential at the corresponding connection position on the conductive wire 431. As the potential varies in a step-like distribution along the conductive wire 431, different positions on the conductive wire 431 have different potentials. Due to the different connection positions of the equipotential wires 44 on the conductive wire 431, the potentials of the equipotential wires are also different. In this embodiment, the potential on the equipotential wires can be controlled by adjusting their connection positions on the conductive wire 431, and further, the shape of these equipotential wires in the second electrode layer 40 can accurately control the potential in different regions near the liquid crystal layer. The shape of the conductive wire 431 can be any curve that satisfies one of the aforementioned equations.

As one optional but advantageous embodiment, the shape of the conductive wire 431 in this embodiment is a spiral, which can be any of the aforementioned spiral shapes.

As a preferred embodiment, the shape of the multiple equipotential wires 44 is a series of concentric circles with different radii. Each equipotential wire corresponds to a concentric circle, and these concentric circles are arranged in successive layers from the innermost to the outermost. Each concentric circle controls the potential magnitude in the region with the same radius. As a preferred embodiment, the shape of the multiple equipotential wires 44 is a series of concentric circular arcs with different radii. Each equipotential wire is a concentric arc, and a concentric arc is a part of a complete circle concentric to it. By using the aforementioned spiral conductive wire 431 combined with electrode structure of the same circle or concentric arc, the potential at different diametric positions of the liquid crystal lens can be accurately controlled. Since these concentric circles or circular arcs are densely distributed in the functional area of the liquid crystal lens, this embodiment precisely controls the potential at various positions in the functional area of the liquid crystal lens through the aforementioned structure. As a preferred approach, a high-resistance film is placed between the second electrode layer and the liquid crystal layer in this embodiment. Unlike the current use of high-resistance films to guide the potential distribution of liquid crystal lenses, the high-resistance film in this embodiment, placed between the adjacent conductive wires, is mainly used to reduce the spatial variation of the electric field near the conductive wires. Since the spacing between the adjacent conductive wires is less than 100 μm and the potential distribution is mainly determined by the conductive wires, the influence of the change in the characteristics of the high-resistance film on the potential distribution can be negligible.

In addition, an additional approach to reducing the spatial variation of the electric field near the conductive wires is to employ a high-resistance film between the second electrode layer and the second transparent substrate, or to incorporate an insulating layer between the second electrode layer and the liquid crystal layer, or to combine an insulating layer between the second electrode layer and the liquid crystal layer with a high-resistance film between the insulating layer and the liquid crystal layer.

### Embodiment 2

This embodiment provides a driving method for a liquid crystal lens as claimed in any one of claims 1 to 7. The voltage applied between the first electrode layer 20 and the first electrical connector is denoted as V1, and the voltage applied between the second electrical connector and the first electrode layer 20 is denoted as V2, the method comprises the following steps of:

S1: obtaining a linear response voltage range of the liquid crystal lens; wherein the linear working range of the liquid crystal lens refers to the voltage range where the phase delay of the liquid crystal exhibits a linear relationship with the driving voltage.

S2: determining a minimum voltage Vₘᵢₙ and a maximum voltage Vₘₐₓ within the linear response voltage range of the liquid crystal lens.

S3: adjusting the voltage difference between V1 and V2 based on the minimum voltage Vₘᵢₙ and maximum voltage Vₘₐₓ to control the focal power of the liquid crystal lens, wherein Vₘᵢₙ≤V1≤Vₘₐₓ and Vₘᵢₙ≤V2≤Vₘₐₓ.

This step involves adjusting the focal power of the liquid crystal lens by manipulating the value of V1-V2. Specifically, the focal power can be adjusted by keeping V1 constant and changing the value of V2, or by keeping V2 constant and changing the value of V1, and alternatively, both V1 and V2 can be simultaneously adjusted. When V1 is kept constant and V2 is adjusted, V1 can be set to either Vₘᵢₙ or Vₘₐₓ while modifying the value of V2. Similarly, when V2 is kept constant and V1 is adjusted, V2 can be set to either Vₘᵢₙ or Vₘₐₓ while adjusting the value of V1. In this embodiment, the relationship between V1 and V2 can also be altered to switch between positive and negative lens states of the liquid crystal lens.

### Embodiment 3

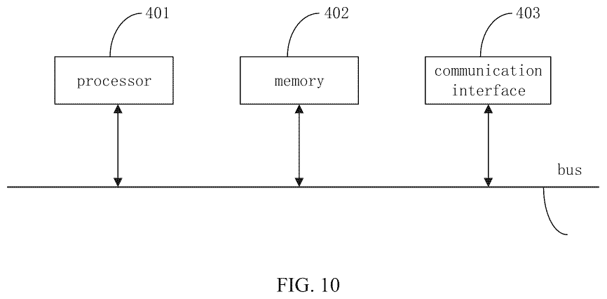

Furthermore, the driving method for the liquid crystal lens described in the foregoing embodiments of the present invention, in conjunction with the hardware structure depicted in FIG. 10, can be implemented by a driving device for liquid crystal lens provided in the present embodiment of the invention. FIG. 10 illustrates a schematic diagram of the hardware structure of a driving device for the liquid crystal lens provided in an exemplary embodiment of the present invention.

The driving device for liquid crystal lens in this embodiment can include a processor 401 and a memory 402 that stores computer program instructions.

Specifically, the processor 401 mentioned above can include a central processing unit (CPU), or an Application-Specific Integrated Circuit (ASIC), or can be configured to implement one or more integrated circuits for the embodiments of the present invention.

The memory 402 can include a large-capacity storage for data or instructions. For example, but not limited to, the memory 402 may include a hard disk drive (HDD), floppy disk drive, flash memory, optical disc, magneto-optical disc, magnetic tape, or Universal Serial Bus (USB) drive, or a combination of two or more of these. In appropriate cases, the memory 402 can include removable or non-removable (or fixed) media. In suitable cases, the memory 402 can be internal or external to the data processing apparatus. In specific embodiments, the memory 402 is a non-volatile solid-state memory. In specific embodiments, the memory 402 includes read-only memory (ROM). In appropriate cases, the ROM can be mask-programmed ROM, programmable ROM (PROM), erasable PROM (EPROM), electrically erasable PROM (EEPROM), electrically alterable ROM (EAROM), flash memory, or a combination of two or more thereof.

The processor 401 reads and executes the computer program instructions stored in the memory 402 to implement any of the driving methods for liquid crystal lens described in the above embodiments. In one example, the driving device for liquid crystal lens of this embodiment may further include a communication interface 403 and a bus 410. As shown in FIG. 10, the processor 401, memory 402, and communication interface 403 are connected via the bus 410 to facilitate communication between them.

The communication interface 403 is primarily used to enable communication between various modules, devices, units, and/or apparatus in the embodiments of the present invention.

The bus 410, which may include hardware, software, or both, interconnects the various components together. For example, but not limited to, the bus may include Accelerated Graphics Port (AGP) or other graphics buses, Enhanced Industry Standard Architecture (EISA) bus, Front Side Bus (FSB), HyperTransport (HT) interconnect, Industry Standard Architecture (ISA) bus, InfiniBand interconnect, Low Pin Count (LPC) bus, Memory bus, Micro Channel Architecture (MCA) bus, Peripheral Component Interconnect (PCI) bus, PCI-Express (PCI-X) bus, Serial Advanced Technology Attachment (SATA) bus, Video Electronics Standards Association Local (VLB) bus, or any other suitable bus or combination of two or more of these buses. In appropriate cases, the bus 410 may include one or more buses. Although specific buses have been described and illustrated in the embodiments of the present invention, the invention contemplates any suitable bus or interconnect.

### Embodiment 4

In addition, in conjunction with the above-described embodiments of the driving method for liquid crystal lens, the present invention provides a computer-readable storage medium for implementation. The computer-readable storage medium stores computer program instructions, which, when executed by a processor, implement any of the driving methods for liquid crystal lens described in the above embodiments of the present invention.

### Embodiment 5

The embodiment relates to a pair of eyeglasses comprising the liquid crystal lens described in embodiment 1. The eyeglasses include a left lens and a right lens, with each lens having the liquid crystal lens described in embodiment 1. The eyeglasses further include a control circuit comprising a first focusing circuit and a second focusing circuit. The first focusing circuit is electrically connected to the liquid crystal lens in the left lens and is used to adjust the optical focal length of the liquid crystal lens in the left lens. The second focusing circuit is electrically connected to the liquid crystal lens in the right lens and is used to adjust the focal power of the liquid crystal lens in the right lens.

### Embodiment 6

The embodiment provides an electronic device comprising a control circuit and any one of the liquid crystal lenses described in embodiment 1. The control circuit is electrically connected to the liquid crystal lens. The electronic device can include, but is not limited to, imaging devices, display devices, mobile phones, wearable devices, and the like.

### Embodiment 7

The embodiment provides an AR (Augmented Reality) device comprising the liquid crystal lens described in embodiment 1. In addition, the AR device includes a first lens assembly and a second lens assembly. The first lens assembly includes at least one liquid crystal lens as described in embodiment 1, and the second lens assembly includes at least one liquid crystal lens as described in embodiment 1. The AR device further includes a first focusing circuit and a second focusing circuit. The first focusing circuit is electrically connected to the liquid crystal lens in the first lens assembly and is used to adjust the focal length of the liquid crystal lens in the first lens assembly. The second focusing circuit is electrically connected to the liquid crystal lens in the second lens assembly and is used to adjust the focal power of the liquid crystal lens in the second lens assembly. In this embodiment, the first lens assembly corresponds to the user's left eye, and the second lens assembly corresponds to the user's right eye.

In the AR device, since the left and right eyes correspond to different screens, there are two sets of lens assemblies that correspond to the left and right eyes, respectively. Due to variations in the interpupillary distance among different users, maintaining a constant focal length in the lens assemblies would result in suboptimal user experience for some users when wearing AR glasses. Additionally, due to variations in facial features among consumers, the AR glasses in this embodiment can utilize the liquid crystal lens described in embodiment 1 to achieve focal length adjustment. By adjusting both the IPD and the focal length to appropriate positions, the images can be accurately projected onto the retina, resulting in clear images and providing users with a better viewing experience.

### Embodiment 8

This embodiment provides a VR device that includes the liquid crystal lens described in embodiment 1. The VR device comprises a third lens assembly and a fourth lens assembly. The third lens assembly includes at least one liquid crystal lens described in embodiment 1, and the fourth lens assembly includes at least one liquid crystal lens described in embodiment 1. The VR device further includes a third focusing circuit and a fourth focusing circuit. The third focusing circuit is electrically connected to the liquid crystal lens in the third lens assembly and is used to adjust the focal length of the liquid crystal lens in the third lens assembly. The fourth focusing circuit is electrically connected to the liquid crystal lens in the fourth lens assembly and is used to adjust the focal length of the liquid crystal lens in the fourth lens assembly. In this embodiment, the third lens assembly corresponds to the user's left eye, and the fourth lens assembly corresponds to the user's right eye.

In the VR device, as the left and right eyes correspond to different screens, there are two sets of lens assemblies specifically designed for the left and right eyes. Since the interpupillary distance varies among different users, keeping the focal length of the lens assemblies constant would result in varying user experiences when wearing the VR goggles. Additionally, users have different facial features and head shapes. Therefore, in this embodiment, the VR goggles utilize the liquid crystal lens described in embodiment 1 to achieve focal length adjustment. By adjusting both the IPD and the focal length to appropriate positions, the images can be accurately projected onto the users' retinas, resulting in clear visuals and an enhanced user experience.

The above is a detailed description of the liquid crystal lens driving method, apparatus, device, and storage medium provided in this embodiment of the invention.

It should be clear that the present invention is not limited to the specific configurations and processes described above and shown in the drawing. For simplicity, detailed description of known methods is omitted here. In the above embodiments, several specific steps are described and shown as examples. However, the method of the present invention is not limited to the specific steps described and shown. Those skilled in the art can make various changes, modifications and additions, or change the order between the steps within the spirit of the present invention.

The functional blocks shown in the above-described block diagrams can be implemented as hardware, software, firmware, or a combination thereof. When implemented in hardware, they can be electronic circuits, application-specific integrated circuits (ASICs), appropriate firmware, plugins, functional cards, and so on. When implemented in software, the elements of the present invention are programs or code segments used to perform the required tasks. The programs or code segments can be stored in machine-readable media or transmitted through data signals carried by a carrier in a transmission medium or communication link. “Machine-readable media” can include any media capable of storing or transmitting information. Examples of machine-readable media include electronic circuits, semiconductor storage devices, ROM, flash memory, erasable ROM (EROM), floppy disks, CD-ROMs, DVDs, hard drives, optical media, fiber media, radio frequency (RF) links, and the like. Code segments can be downloaded via computer networks such as the Internet, intranets, and the like.

Indeed, it should be noted that the exemplary embodiments mentioned in the present invention describe methods or systems based on a series of steps or devices. However, the present invention is not limited to the order of the steps described above. In other words, the steps can be performed in the order mentioned in the embodiments, or they can be performed in a different order or simultaneously.

The above description is only specific embodiments of the present invention. Those skilled in the art will understand that, for the sake of convenience and conciseness, the specific operation processes of the described systems, modules, and units can refer to the corresponding processes described in the previous method embodiments, and are not repeated here. It should be understood that the scope of protection of the present invention is not limited thereto, and any modifications or substitutions that those skilled in the art can easily contemplate within the technical scope disclosed in the present invention are also encompassed within the scope of protection of the present invention.

What is claimed is:

1. A liquid crystal lens, comprising a liquid crystal layer, a first electrode layer, a second electrode layer, a first transparent substrate, and a second transparent substrate, wherein the first electrode layer and the second electrode layer are respectively located on opposite sides of the liquid crystal layer, the first transparent substrate is positioned on one side of the first electrode layer opposite to the liquid crystal layer, and the second transparent substrate is positioned on one side of the second electrode layer opposite to the liquid crystal layer;
the second electrode layer includes a first electrical connector, a second electrical connector, and several conductive wires, the conductive wires extend from the center of the second electrode layer towards the periphery, one end of the conductive wires is electrically connected to the first electrical connector, and the opposite end is connected to the second electrical connector, the first electrical connector provides a first driving voltage to the end portions of the conductive wires electrically connected thereto, while the second electrical connector provides a second driving voltage to the end portions of the conductive wires electrically connected thereto, the spacing between adjacent conductive wires is equal to or less than 100 μm.

2. The liquid crystal lens as defined in claim 1, wherein the first electrical connector is used to provide the same driving voltage to the end portions of each conductive wire electrically connected thereto, and/or the second electrical connector is used to provide the same driving voltage to the end portions of each conductive wire electrically connected thereto, and/or the second electrical connector is in the form of a perforated electrode.

3. The liquid crystal lens as defined in claim 1, wherein said the several conductive wires are arranged in a rotating symmetric manner around a point in the second electrode layer.

4. The liquid crystal lens as defined in claim 1, wherein the first electric connector is a first electrode lead, which is led outwards from one end of the conductive wires near the center of the second electrode layer, the conductive wire comprises multiple curved segments arranged from outer to inner, each curved segment is disconnected at the electrode lead, wherein the outermost curved segment is connected to the second electric connector at one end and connected to the adjacent curved segment on the same side as the first electrode lead at the opposite end, the end of the curved segment closest to the center of the second electrode layer is electrically connected to the first electrode lead at one end and connected to the adjacent segment on the same side as the first electrode lead at the opposite end, the remaining curved segments are connected to an adjacent curved segment on the same side as the first electrode lead at one end and connected to another adjacent curved segment on the same side as the first electrode lead at the opposite end.

5. The liquid crystal lens as defined in claim 4, wherein the curved segment is an arc, and the spacing between adjacent curved segments is equal or unequal.

6. The liquid crystal lens as defined in claim 4, wherein the spacing between adjacent curved segments satisfies a potential distribution formed by the liquid crystal lens to be a spherical distribution, a conical distribution, or a parabolic distribution.

7. The liquid crystal lens as defined in claim 1, wherein the shape of the conductive wires is a spiral.

8. The liquid crystal lens as defined in claim 7, wherein the shape of the conductive wires is a spiral obtained from a first helix equation, the second helix equation, or a third helix equation;
the first helix equation is as follow:
$$\{ \begin{matrix}x = r cos ( g ( r ) ) \\ y = r sin ( g ( r ) )\end{matrix}$$
wherein:
$$g ( r ) = \pm ( \sqrt{4 {a}^{2} {r}^{2} - 1} - arctan ( \sqrt{4 {a}^{2} {r}^{2} - 1} ) )$$
wherein ‘r’ represents the radius in polar coordinates, g(r) represents the polar angle, and ‘a’ is a parameter in the equation;
the second helix equation is as follow:
$$\{ \begin{matrix}x = r cos ( g ( r ) ) \\ y = r sin ( g ( r ) )\end{matrix}$$
wherein:
$$g ( r ) = \text{} \pm ( arctan ( \frac{\sqrt{{R}^{2} - {r}^{2}}}{\sqrt{( {m}^{2} + 1 ) {r}^{2} - {R}^{2}}} ) + \sqrt{{m}^{2} + 1} arc sin h ( \frac{\sqrt{{m}^{2} + 1} \sqrt{{R}^{2} - {r}^{2}}}{m R} ) )$$
wherein ‘r’ represents the radius in polar coordinates, m represents a parameter related to the liquid crystal material, and R is the curvature radius of the lens;
The third helix equation is as follow:
$$\{ \begin{matrix}x = r cos ( g ( r ) ) \\ y = r sin ( g ( r ) )\end{matrix}$$
wherein ‘r’ represents the radius in polar coordinates, g(r) represents the polar angle;
$$g ( r ) = \pm \sqrt{4 {a}^{2} - 1} ln ( r ) + c$$
wherein ‘c’ is an arbitrary constant and ‘a’ is a parameter of the equation.

9. The liquid crystal lens as defined in claim 1, wherein the number of conductive wires is one, and the second electrode layer further includes several equipotential wires, said several equipotential wires are electrically connected to the conductive wire at different positions along the conductive wire.

10. The liquid crystal lens as defined in claim 9, wherein the shape of the conductive wire is a helix.

11. The liquid crystal lens as defined in claim 9, wherein the shape of the several equipotential lines is a series of concentric circular with different radii.

12. The liquid crystal lens as defined in claim 9, wherein the shape of the several equipotential wires is a series of concentric circular arcs with different radii.

13. The liquid crystal lens as defined in claim 1, wherein a high-resistance film is provided between the second electrode layer and the liquid crystal layer, or between the second electrode layer and the second transparent substrate.

14. The liquid crystal lens according to claim 1, wherein an insulating layer is provided between the second electrode layer and the liquid crystal layer.

15. The liquid crystal lens according to claim 14, wherein a high-resistance film is provided between the insulating layer and the liquid crystal layer.

16. Eyeglasses, comprising the liquid crystal lens according to claim 1.

17. A VR device, comprising the liquid crystal lens according to claim 1.

18. An AR device, comprising the liquid crystal lens according to claim 1.

19. An electronic product, comprising a control circuit and the liquid crystal lens according to claim 1, wherein the control circuit is electrically connected to the liquid crystal lens.

20. A driving method for liquid crystal lens, used for driving the liquid crystal lens according to claim 1, wherein the voltage applied between the first electrode layer and the first electrical connector is denoted as V1, and the voltage applied between the second electrical connector and the first electrode layer 20 is denoted as V2, the method comprises the following steps of:
S1: obtaining a linear response voltage range of the liquid crystal lens;
S2: determining a minimum voltage Vₘᵢₙ and a maximum voltage Vₘₐₓ within the linear response voltage range of the liquid crystal lens.
S3: adjusting the voltage difference between V1 and V2 based on the minimum voltage Vₘᵢₙ and maximum voltage Vₘₐₓ to control the focal power of the liquid crystal lens, wherein Vₘᵢₙ≤V1≤Vₘₐₓ and Vₘᵢₙ≤V2≤Vₘₐₓ.
